(19) United States
(12) Patent Application Publication
(10) Pub. No.: US 2007/0258339 A1
(43) Pub. Date: Nov. 8, 2007

(54) Information Recording Medium

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 11/632,039

(22) PCT Filed: Jul. 13, 2005
(86) PCT No.: PCT/JP05/12899

§ 371 Date: Mar. 12, 2007

(30) Foreign Application Priority Data
Jul. 13, 2004 (JP) 2004-206185

(51) Int. Cl. G11B 19/02; G11B 15/52

(52) U.S. Cl. 369/47.12

(57) ABSTRACT

An information recording medium is provided with a recording information recording area (R) capable of recording reproduction control information (e.g., PGC) and first recording information to be reproduced according the reproduction control information, an encoding information recording area (CDZ) having encoding information (Key “B”) recorded in advance for encoding the first recording information, and a reproduction only area (ROM) having second recording information (B) recorded in advance for being reproduced according to the reproduction control information.

### TECHNICAL FIELD

The present invention relates to an information recording medium, such as a DVD.

### BACKGROUND ART

A patent document 1 or the like discloses a distribution or delivery system for recording in advance encryption information onto a record type information recording medium, such as a DVD-R/RW, selling it, and distributing encrypted DVD video contents (hereinafter referred to as “encrypted contents”, as occasion demands) through a network. In this distribution system, encryption information applied to a conventional read-only type information recording medium, such as a DVD-ROM, is prerecorded before sale in a control area, such as a control data zone, on an information recording medium having the same physical structure as that of the conventional record type information recording medium, such as the DVD-R/RW.

Moreover, there is also proposed a hybrid type information recording medium having: a recordable recording area which is the same as that of a recordable type optical disc, such as a CD-R and a DVD-R, for example; and a read-only area which is the same as that of a read-only type optical disc, such as CD-ROM and a DVD-ROM, for example, on an outer circumferential area and an inner circumferential area of one optical disc.

Patent document 1: Japanese Patent Application Laying Open NO. 2001-307427

Patent document 2: Japanese Patent Application Laying Open NO. 2001-357001

Patent document 3: Japanese Patent Application Laying Open NO. 2000-331412

Nonpatent document 1: “DVD content protection”, Toshiba review, Vol. 58, No 6 (2003)

### DISCLOSURE OF INVENTION

### Subject to be Solved by the Invention

However, in the above-mentioned patent document 1, the record type information recording medium is not specially designed, and the encryption information having the same mechanism as that of the read-only type DVD (DVD-ROM) is prerecorded in the recording area having the same physical structure as that of the conventional record type information recording medium. Thus, if a disc in a not-prerecorded condition distributes in market, there is such a technical problem that the entire information on the read-only type DVD is possibly copied to the relevant disc.

Moreover, in an existing rule about the reproduction or recording of the encrypted contents, it is not recommended that the encryption information, such as a disk key, is recorded onto the record type DVD disc. Therefore, on an information recording/reproducing apparatus, when the type of media is judged by a seek operation for obtaining control information or by similar operations, disc identification information recorded on the disc is checked. However, there is also illegal equipment capable of writing the disc identification information indicating the read-only type DVD onto the record type DVD disc. Thus, there is such a technical problem that it is hardly possible to correctly distinguish both the legal record type DVD disc and the illegal record type DVD disc only by checking the disc identification information.

Moreover, the distributed DVD video contents includes DVD video contents which are common by a unit of each film company, such as opening video images, like a picture of mountains, a picture of the earth, or a company's theme song, which are peculiar to a film distribution company and a production company, for example. Thus, there is such a technical problem that it redundantly takes a time if the DVD video contents are distributed every time.

Moreover, the DVD video contents, such as opening video images, vary in units of film companies. Thus, there is such a technical problem that it is difficult to record a plurality of types of DVD video contents by forming embossed pits on the above-mentioned hybrid type optical disc by using the same stampa.

It is therefore an object of the present invention to provide an information recording medium, which enables efficient distribution of encrypted contents to the record type information recording medium.

### MEANS FOR SOLVING THE SUBJECT

(Information Recording Medium)

Hereinafter, the information recording medium of the present invention will be explained.

The above object of the present invention can be achieved by an information recording medium, provided with: a record information recording area (e.g. a R area, such as a data area) in which (i) reproduction control information (e.g. PGC: Program Chain) and (ii) first record information (contents) reproduced in accordance with the reproduction control information can be recorded; an encryption information recording area (e.g. a control data zone) in which encryption information (a disk key) for encrypting at least one of the reproduction control information and the first record information is recorded in advance; and a read-only area (a ROM area) in which second record information (opening video images like “mountain”, “lion”, etc.) reproduced in accordance with the reproduction control information, is prerecorded in advance.

According to the information recording medium of the present invention, it is possible to realize a hybrid type information recording medium provided with the record information recording area and the read-only area including the encryption information recording area. In the encryption information recording area, such as a control data zone, for example, the encryption information applied to a conventional read-only type information recording medium, such as a DVD-ROM, is prerecorded by laser light in addition to or instead of the formation of embossed pits. In the record information recording area, such as a data area, for example, the information, such as the reproduction information and the first record information, encrypted by the encryption information, can be recorded. In the read-only area, such as a ROM area, for example, the second record information is prerecorded in advance by forming embossed pits or by irradiating the laser light.

As a result, it is possible to efficiently distribute all the DVD video contents including the first record information.

If the second record information is not prerecorded in advance, it is necessary to distribute the DVD video contents which are common to movie contents, such as opening video images corresponding to each film company, for example, every time. Thus, it redundantly takes a time.

In contrast, according to the present invention, the second record information, which is the common DVD video contents, such as opening video images, for example, (i) is prerecorded in advance in the read-only area by forming embossed pits or by irradiating the laser light, and (ii) is sold as the record type DVD disc. Therefore, it is unnecessary to distribute the second record information e.g., the common DVD video contents every time, which allows a reduction in time to distribute all the DVD video contents.

Moreover, according to the present invention, a general information recording/reproducing apparatus (i) decodes the distributed and recorded first record information by using the encryption information, and (ii) associates the decoded first record information with the second record information on the basis of the reproduction control information. Moreover, the both information can be reproduced, simultaneously or in tandem. For example, the reproduction control information, such as PGC (Program Chain), may be recorded onto the information recording medium, together with the first record information or separately for the first record information.

Incidentally, with regard to the second record information, such as opening video images, its illegal copy damages only a little in terms of copyright. Thus, it is possible to simplify an encryption system on the entire distribution system, by omitting the encryption of the second record information.

Moreover, it is possible to comply with a rule of recommending the recording of the encryption information, such as a disk key, onto the read-only type DVD disc, which is an existing rule about the reproduction or recording of the encrypted contents.

Thus, on the general information recording/reproducing apparatus, when the type of media is judged by a seek operation for obtaining control information or by similar operations, it is detected whether or not there is wobble formed on the information recording medium. There is no wobble in the read-only area, so that it is possible to accurately distinguish the legal record type DVD disc and the illegal record type DVD disc, on the basis of the detection operation of detecting the wobble in a predetermined area.

In one aspect of the information recording medium of the present invention, the second record information is encrypted and prerecorded on the basis of the encryption information.

According to this aspect, it is possible to associate the first record information, such as main story movie contents, for example, with the second record information, such as opening video images, for example, by using only one kind of encryption information. Thus, it is possible to realize a more highly convenient encryption system.

In another aspect of the information recording medium of the present invention, a plurality of second record information is prerecorded in the read-only area, correspondingly to a plurality of type of contents, and the reproduction control information specifies at least one of the plurality of second record information and allows the reproduction thereof.

According to this aspect, it is possible to prerecord in advance the plurality of second record information, such as opening video images corresponding to each film company, for example, into the read-only area by virtue of the formation of embossed pits using the same stampa. Thus, the general information recording/reproducing apparatus (i) decodes the distributed and recorded first record information by using the encryption information, and (ii) associates the decode first record information with the particular second record information out of the plurality of second record information, on the basis of the reproduction control information. Moreover, the both information can be reproduced, simultaneously or in tandem.

As a result, it is possible to manufacture the hybrid type information recording medium corresponding to a plurality of film companies, inexpensively and in large quantities

In an aspect associated with the read-only area and the encryption information recording area described above, the plurality of second record information (picture of “mountain”, “lion”, etc.) may (i) be respectively encrypted by a mutually different plurality of encryption information and (ii) be respectively prerecorded in advance in the read-only area, and one of the plurality of encryption information (Key2) may be prerecorded in advance in the encryption information recording area.

By virtue of such construction, it is possible (i) to encrypt the plurality of second record information, such as opening video images corresponding to each film company, for example, by using the respective plurality of encryption information and (ii) to prerecord the second record information in advance into the read-only area by virtue of the formation of embossed pits using the same stampa. Thus, the general information recording/reproducing apparatus (i) decodes the distributed and recorded first record information by using the one kind of encryption information, and (ii) decodes the particular second record information out of the plurality of second record information on the basis of the one kind of encryption information. Moreover, the both information can be reproduced, simultaneously or in tandem.

As a result, it is possible to manufacture the hybrid type information recording medium corresponding to a plurality of film companies, inexpensively and in large quantities

In an aspect associated with the read-only area and the encryption information recording area described above, all the plurality of second record information (picture of “mountain”, “lion”, etc.) may be encrypted by one kind of encryption information (Key1) and prerecorded in advance in the read-only area, and the one kind of encryption information (Key1) may be prerecorded in advance in the encryption information recording area.

By virtue of such construction, it is possible (i) to encrypt the plurality of second record information, such as opening video images corresponding to each film company, for example, by using the one kind of encryption information and (ii) to prerecord it into the read-only area by virtue of the formation of embossed pits using the same stampa. Thus, the general information recording/reproducing apparatus (i) decodes the distributed and recorded first record information by using the one kind of encryption information, and (ii) associates it with the particular second record information out of the plurality of second information, on the basis of the reproduction control information. Moreover, the both information can be reproduced, simultaneously or in tandem.

As a result, it is possible to manufacture the hybrid type information recording medium corresponding to a plurality of film companies, inexpensively and in large quantities

In addition, by that a plurality of film companies share the one kind of encryption information, such as a title key, for example, it is possible to realize a more highly convenient encryption system.

In another aspect of the information recording medium of the present invention, the second record information (picture of “FBI (Federal Bureau of Investigation) copyright notice”) is prerecorded without being encrypted by the encryption information (common Key).

According to this aspect, with regard to the second record information, such as warning video images about copyright by FBI (Federal Bureau of Investigation), the image's illegal copy damages only a little in terms of copyright. Thus, it is possible to simplify an encryption system on the entire distribution system, by omitting the encryption of the second record information.

In addition, it is also possible to simplify a procedure of reproducing the second record information by using the reproduction control information.

In another aspect of the information recording medium of the present invention, the encryption information (e.g. a disk key) is information for further encrypting another encryption information (e.g. a title key) for encrypting the first record information, and the another encryption information is recorded into the record information recording area with the first record information.

According to this aspect, it is possible to make the correlation of the encryption information, such as an encryption key, in a hierarchy structure. Therefore, it is possible for an owner of copyright and a disc manufacturer or the like to arbitrarily set the encryption key, to thereby establish a highly convenient encryption system.

In another aspect of the information recording medium of the present invention, it is further provided with a control information recording area (e.g. a control data zone) in which control information about reproduction control and recording control, can be recorded, flag information being recorded in the control information recording area, the flag information indicating whether or not there is the read-only area.

According to this aspect, the flag information recorded in the control information recording area is obtained by the initial operation of the general information recording/reproducing apparatus, for example, wherein the flag information indicates whether or not there is the read-only area. Therefore, by that the information recording/reproducing apparatus identifies the flag information, it is possible to quickly judge whether or not it is necessary to download the information corresponding to the second record information recorded in the read-only area.

In addition, by that the information recording/reproducing apparatus identifies the flag information, it is possible to distinguish the legal record type information recording medium and the illegal type information recording medium, accurately and quickly.

Incidentally, the information recording/reproducing apparatus may transmit the flag information to an information distributing apparatus for distributing the first record information, with identification information for identifying the information recording medium, such as media ID, for example. Therefore, the information distributing apparatus can accurately and quickly judge whether or not to distribute the information corresponding to the second record information.

In this case, moreover, at least one of (i) attribute information about attribute and the number of the second record information prerecorded in the read-only area, (ii) start address information, and (iii) end address information may be recorded in the control information recording area, (ii-a) the start address information indicating a start position of the read-only area, (iii-a) the end address information indicating an end position of the read-only area.

By virtue of such construction, at least one of the various information about the second record information and the read-only area, recorded in the control information recording area, is obtained by the initial operation of the general information recording/reproducing apparatus, for example. Therefore, the information recording/reproducing apparatus and the information distributing apparatus can properly perform the recording/reproduction and the distribution, in accordance with the various information.

In another aspect of the information recording medium of the present invention, pre-format address information is recorded in at least one of the record information recording area and the encryption information recording area, and flag information indicating whether or not there is the read-only area is appended to the pre-format address information.

According to this aspect, the flag information is obtained by the general information recording/reproducing apparatus, for example, wherein the flag information indicates whether or not there is the read-only area appended to the pre-format address information in at least one of the record information recording area and the encryption information recording area. Here, the expression “appended” or “appended to the pre-format address information” means that information is recorded in the same method as in the pre-format address information, such as address information by pre-pits, for example, or as pre-information inserted before or after the arrangement (i.e., front position or rear position of the arrangement) of the pre-format address information or inserted in the middle of the arrangement of the pre-format address information.

Therefore, by that the information recording/reproducing apparatus identifies the flag information, it is possible to quickly judge whether or not it is necessary to download the information corresponding to the second record information recorded in the read-only area.

In addition, by that the information recording/reproducing apparatus identifies the flag information, it is possible to distinguish the legal record type information recording medium and the illegal type information recording medium, accurately and quickly.

Incidentally, the information recording/reproducing apparatus may transmit the flag information to an information distributing apparatus for distributing the first record information, with identification information for identifying the information recording medium, such as media ID, for example. Therefore, the information distributing apparatus can judge whether or not to distribute the information corresponding to the second record information.

In addition, the information recording/reproducing apparatus obtains the flag information from the pre-format address information, so that it is possible to simplify the initial operation.

In this case, moreover, at least one of (i) attribute information about attribute and the number of the second record information prerecorded in the read-only area, (ii) start address information, and (iii) end address information may be appended to the pre-format address information, (ii-a) the start address information indicating a start position of the read-only area, (iii-a) the end address information indicating an end position of the read-only area.

By virtue of such construction, at least one of the various information about the second record information and the read-only area, appended to the pre-format address information in at least one of the record information recording area and the encryption information recording, is obtained by the general information recording/reproducing apparatus, for example. Therefore, the information recording/reproducing apparatus and the information distributing apparatus can properly perform the recording/reproduction and the distribution, in accordance with the various information.

These effects and other advantages of the present invention will become more apparent from the following embodiment.

As explained above, according to the information recording medium of the present invention, it is provided with: the record information recording area in which the reproduction control information and the first record information reproduced in accordance with the reproduction control information can be recorded; the encryption information recording area in which the encryption information for encrypting at least one of the reproduction control information and the first record information is recorded in advance; and the read-only area in which second record information reproduced in accordance with the reproduction control information is recorded in advance. Moreover, at least one of the reproduction control information and the first record information is encrypted and recorded on the basis of the encryption information. Thus, it is unnecessary to distribute the common DVD video contents every time, which allows a reduction in time to distribute all the DVD video contents.

### BRIEF DESCRIPTION OF DRAWINGS

FIG. 1 is a substantial plan view showing the basic structure of an optical disc having a plurality of recording areas in an embodiment of the information recording medium of the present invention in an upper part, and a corresponding conceptual view showing a recording area structure in the radial direction in a lower part.

FIG. 2 is a partially enlarged perspective view showing the recording surface of the optical disc in the embodiment. [FIG. 3] FIG. 3 is a schematic conceptual view showing one specific example of the physical structure of the recording areas of the optical disc in the embodiment of the information recording medium of the present invention.

FIG. 4 is a block diagram showing the entire structure of a distribution system provided with: an information recording apparatus for performing a recording operation; and an information distributing apparatus for performing a distribution operation, with respect to the information recording medium of the present invention.

FIG. 5 is a flowchart showing the distribution process on the information recording medium, the information recording/reproducing apparatus, and the information distributing apparatus of the present invention.

FIG. 6 is a block diagram showing the entire structure of an information recording/reproducing apparatus for recording and reproducing information on the information recording medium of the present invention.

FIG. 7 is a flowchart showing a flow of a reproduction operation by a specific example of the embodiment of the information recording/reproducing apparatus of the present invention.

### DESCRIPTION OF REFERENCE CODES

1 . . . center hole, 10 . . . track, 11 . . . sector, 100 . . . optical disc, 101 . . . lead-in area, 102 . . . data area, 103 . . . lead-out area, 106 . . . transparent substrate, 107 . . . recording layer, 108 . . . reflective film, 109 . . . wobble, 200 . . . information recording apparatus, 200a . . . information recording/reproducing apparatus, 201 . . . objective lens, 202 . . . optical pickup, 203 . . . spindle motor, 204 . . . head amplifier, 210 . . . sum generation circuit, 211 . . . pit data demodulation circuit, 212 . . . pit data correction circuit, 213 . . . buffer, 214 . . . interface, 220 . . . push-pull signal generation circuit, 221 . . . low pass filter, 222 . . . servo unit, 225 . . . LPP detection circuit, 229 . . . error correction circuit, 230 . . . LPP demodulation circuit, 250 . . . CPU, 300 . . . information distributing apparatus, 400 . . . external network, SS . . . spread spectrum data, CK1 . . . first clock signal, GT . . . groove track, LT . . . land track, LB . . . laser light, LPP . . . land pre-pit, Key1 . . . encryption information (disk key, disk key set), Key2 . . . encryption information (title key), Key “A”, Key “B”, and Key “C” . . . encryption information, CDZ . . . control data zone, NBCA . . . Narrow Burst Cutting Area, ROM . . . read-only area, R . . . recordable area

### BEST MODE FOR CARRYING OUT THE INVENTION

Hereinafter, the best mode for carrying out the present invention will be discussed by giving embodiments on the basis of the drawings.

(Information Recording Medium)

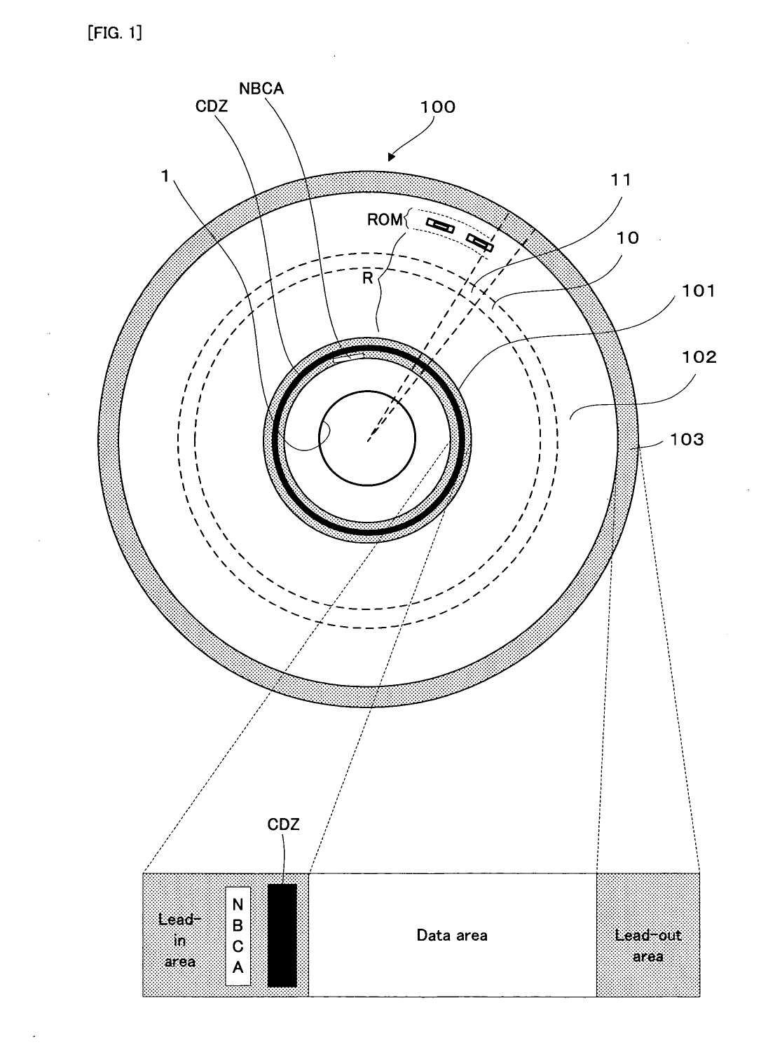

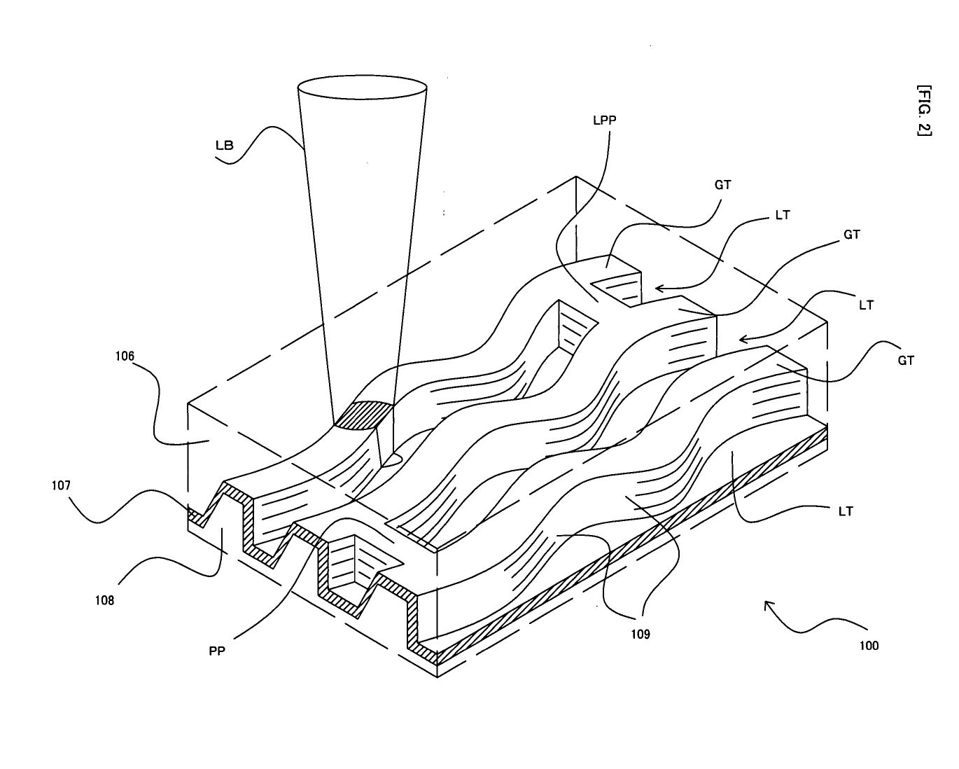

Hereinafter, with reference to FIG. 1 to FIG. 3, an embodiment of the information recording medium of the present invention will be explained.

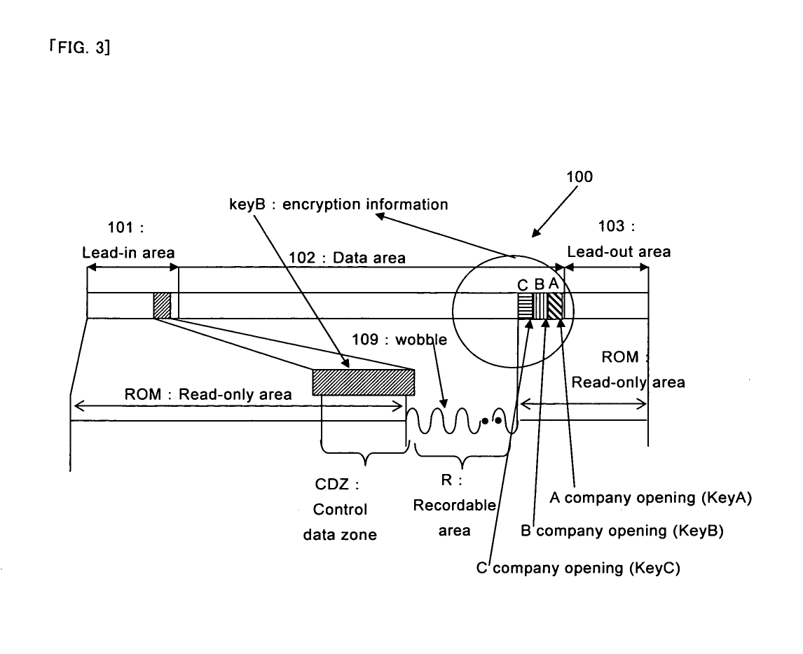

Firstly, with reference to FIG. 1 and FIG. 2, an explanation will be given for the basis structure of an optical disc, which is one specific example of the information recording medium of the present invention. FIG. 1 is a substantial plan view showing the basic structure of the optical disc having a plurality of recording areas in the embodiment of the information recording medium of the present invention in an upper part, and a corresponding conceptual view showing a recording area structure in the radial direction in a lower part. Moreover, FIG. 2 is a partially enlarged perspective view showing the recording surface of the optical disc in the embodiment.

An optical disc 100 in the embodiment, as shown in FIG. 1, is constructed as a hybrid type optical disc, having two types of recording areas; more specifically, a recordable area R and a read-only area ROM, which are classified from the viewpoint of physical properties. In the read-only area ROM, the “second record information” of the present invention is recorded by forming embossed pits, for example. It gives a character as a ROM type optical disc on which the second record information can be reproduced physically many times, by irradiating a reproduction laser. On the other hand, in the recordable area R, additional recording or writing once can be performed as it uses an organic pigment film. Incidentally, as described later, the information recording medium in the embodiment may be constructed such that recording can be performed many times and reproduction can be also performed many times in various irreversible change recording methods by heat or the like.

More specifically, the optical disc 100 has a recording surface on a disc main body with a diameter of about 12 cm, as is a DVD. On the recording surface, the optical disc 100 is provided with: a center hole 1 as the center; a lead-in area 101 as a buffer area in the embodiment; a data area 102; and a lead-out area 103 as another buffer area, from the inner to the outer circumferential side.

The lead-in area 101 is provided with a control data zone CDZ. In the control data zone CDZ, as one portion of the control information for controlling the reproduction and the recording with respect to the optical disc 100, encryption information Key1, such as a disk key and a disk key set, based on a predetermined encryption system is prerecorded. Incidentally, the encryption information Key1, such as a disk key and a disk key set, constitutes one specific example of the “encryption information” of the present invention. Incidentally, the lead-in area 101 may be constructed from a read-only area ROM, as described later.

Moreover, the lead-in area 101 is provided with a NBCA (Narrow Band Cutting Area). In the NBCA, a serial number peculiar to each optical disc 100, i.e. media ID, is recorded in a barcode-shaped pattern by laser cutting. Incidentally, one specific example of the “encryption information recording area” is constructed from the control data zone CDZ. Moreover, the control data zone CDZ is constructed to include a special area CDZa described later.

The data area 102 is constructed from a recordable area R in which encryption information Key2, such as a title key, based on the encryption system, and encrypted contents encrypted by the encryption information Key2, such as a title key, are recorded. More specifically, the encryption information Key2, such as a title key, is encrypted by using the encryption information Key1, such as a disk key and a disk key set. Incidentally, the “another encryption information” of the present invention is constructed from the encryption information Key2, such as a title key. Moreover, one specific example of the “record information recording area” of the present invention is constructed from the data area 102.

Then, in each recording area, a track or tracks 10, such as a groove track and a land track, are alternately placed, spirally or concentrically, centered on the center hole 1.

As shown in FIG. 2, in the embodiment, the optical disc 100 has a pigment type recording layer 107, which constitutes an information recording surface, laminated on the lower side of a disc-shaped transparent substrate 106, and further has a reflective film 108 on the lower side thereof. On the information recording surface constructed from the surface of the recording layer 107, a groove track GT and a land track LT are alternately formed. Incidentally, upon recording and reproduction of the optical disc 100, for example, as shown in FIG. 2, the groove track GT is irradiated with laser light LB through the transparent substrate 106. For example, upon recording, the laser light LB is irradiated with a recording laser power, to thereby perform the recording with respect to the recording layer 107 in accordance with the record data. On the other hand, upon reproduction, the laser light LB is irradiated with a reproduction laser power weaker than the recording laser power, by which the record data recorded in the recording layer 107 is read.

Incidentally, the groove track GT, the land track LT, wobble 109, and a land pre-pit LPP and the like will be explained in detail later.

In FIG. 1 again, on the track 10, data is recorded by a unit of 1 ECC block (cluster), which is a management unit composed of 16 units of sectors 11. The 1 ECC block is a management unit of managing information by using error-correctable pre-format address information.

Incidentally, the present invention is not particularly limited to the optical disc having these four recording areas shown in FIG. 1. For example, the presence of the lead-in area 101 and the lead-out area 103 is arbitrary. It is only necessary to provide at least the data area 102 in which the record data is recorded and a not-illustrated recording area of PCA (Power Calibration Area) for detecting an optimum recording power.

Next, with reference to FIG. 3, a more detailed explanation will be given for a specific example of the physical structure of the recording area of the optical disc in the embodiment of the information recording medium of the present invention. FIG. 3 is a schematic conceptual view showing one specific example of the physical structure of the recording areas of the optical disc in the embodiment of the information recording medium of the present invention.

As shown in FIG. 3, on the optical disc 100 in the embodiment, the lead-in area 101, the lead-out area 103, and portion (or one portion) of the data area 102 are constructed as the read-only area ROM in which wobble 109 is not formed. On the other hand, another portion of the data area 102 is constructed as the recordable area R in which the wobble 109 is formed. In particular, the lead-in area 101 is provided with the control data zone CDZ in which encryption information Key “B”, described later, is prerecorded by laser light, for example.

The outer circumferential portion of the data area 102 is constructed from the read-only area ROM. Here, the “second record information” of the present invention, such as opening video images information, corresponding to three film companies, for example, is prerecorded by forming the embossed pits using the same stampa. The three types of opening video information “A”, “B”, and “C” corresponding to the three film companies are encrypted and prerecorded by using encryption information Key “A”, Key “B”, and Key “C”, respectively. Thus, a general information recording/reproducing apparatus (i) decodes the “first record information” of the present invention, such as distributed and recorded DVD video contents of a company “B”, by using the encryption information Key “B”, and (ii) decodes the opening video information of the company “B” out of the three types of opening video information, on the basis of the encryption information Key “B”. Then, the both information i.e., the DVD video contents of a company “B” and the opening video information of a company “B” can be reproduced, simultaneously or in tandem.

As a result, the common DVD video contents, such as opening video images, for example, (i) are prerecorded in the read-only area ROM by forming the embossed pits, and (ii) are sold as the record type DVD disc. Therefore, it is unnecessary to distribute the common DVD video contents every time, which allows a reduction in time to distribute all the DVD video contents. Moreover, it is possible to manufacture the hybrid type information recording medium corresponding to a plurality of film companies, inexpensively and in large quantities, by encrypting the common DVD video contents corresponding to the plurality of film companies by using plurality of respective encryption information.

In addition, in the control data zone CDZ, flag information may be recorded, wherein the flag information indicates whether or not there is the read-only area ROM. Then, the flag information recorded in the control data zone CDZ, indicating whether or not there is the read-only area ROM, is obtained by the initial operation of a general information recording/reproducing apparatus, for example. Therefore, by that the information recording/reproducing apparatus identifies the flag information, it is possible to quickly judge whether or not it is necessary to download the information corresponding to the second record information (e.g., the common DVD video contents, such as the opening video images) recorded in the read-only area ROM. Moreover, by that the information recording/reproducing apparatus identifies the flag information, it is possible to distinguish the legal record type information recording medium and the illegal record type information recording medium, accurately and quickly. Furthermore, the information recording/reproducing apparatus may transmit the flag information to an information distributing apparatus for distributing the DVD video contents, with identification information for identifying the optical disc, such as media ID, for example. Therefore, the information distributing apparatus can judge whether or not to distribute the information recorded in the read-only area ROM, accurately and quickly, on the basis of the identification information.

In addition, (i) attribute information about the number and attribute of the information prerecorded in the read-only area ROM, (ii) start address information, and (iii) end address information may be recorded in the control data zone CDZ, wherein (ii-a) the start address information indicates the start position of the read-only area ROM and (iii-a) the end address information indicates the end position of the read-only are ROM. Therefore, the information recording/reproducing apparatus and the information distributing apparatus can properly perform the recording/reproduction and the distribution, in accordance with the various information (e.g., the start address information, or the like).

(Entire Structure of Distribution System Provided with Information Recording Medium, Information Recording Apparatus, and Information Distributing Apparatus)

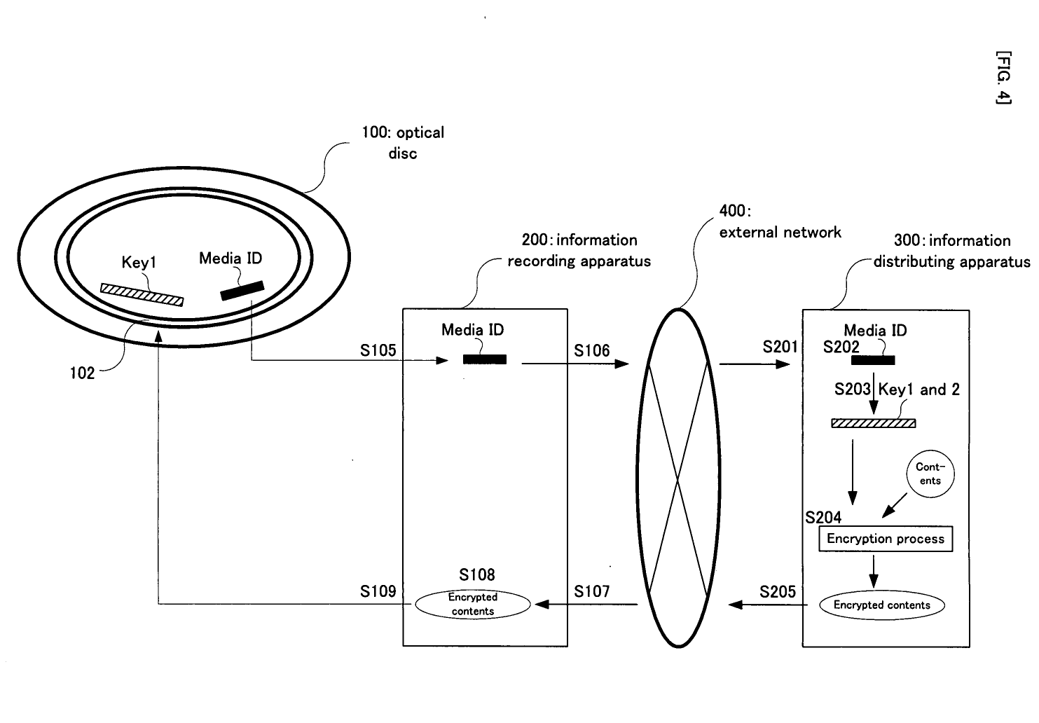

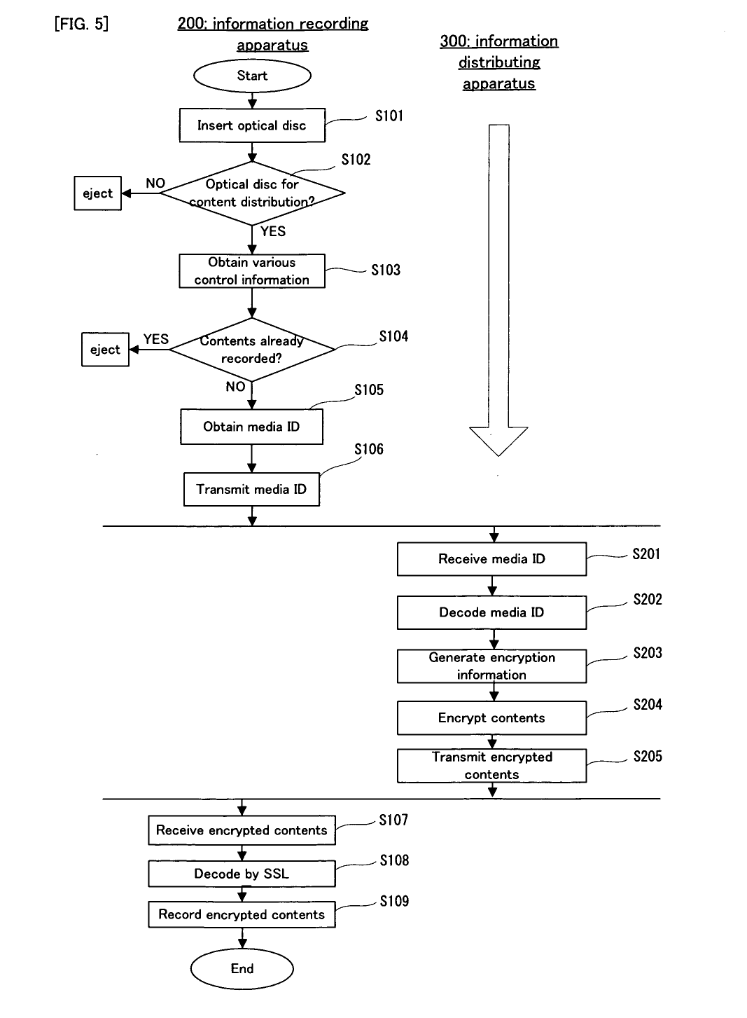

Next, with reference to FIG. 4, an explanation will be given for the entire structure of a distribution system, provided with: an information recording/reproducing apparatus for performing a recording operation on the optical disc on which the encryption information is prerecorded; and an information distributing apparatus for performing a distribution operation. FIG. 4 is a block diagram showing the entire structure of the distribution system, provided with: the information recording apparatus for performing a recording operation on the information recording medium of the present invention; and the information distributing apparatus for performing a distribution operation. Incidentally, step numbers in FIG. 4 correspond to those in FIG. 5 described later. Moreover, in the distribution system in the embodiment, a DAO (Disk At Once) method may be adopted.

As shown in FIG. 4, the distribution system in the embodiment is provided with: (i) an information recording apparatus 200 for performing a recording operation on the optical disc 100; (ii) an information distributing apparatus 300, such as a web server, for distributing encrypted contents to the information recording apparatus 200; and (iii) the external network 400, such as the Internet, for allowing information to be exchanged between the information recording apparatus 200 and the information distributing apparatus 300.

As described above, the optical disc 100 is provided with: the NBCA; the control data zone CDZ; and the data area 102 in which the encrypted contents are recorded. More specifically, in the NBCA, there is recorded the media ID by laser cutting. In the control data zone CDZ, there is recorded the encryption information Key1, such as a disk key. In the data area 102, there are recorded the encrypted contents or the like distributed by the information distributing apparatus 300 described later, as it is.

The information recording apparatus 200 transmits the media ID of the optical disc 100 to the information distributing apparatus 300. Moreover, it records the encrypted contents received from the information distributing apparatus 300, onto the optical disc 100.

The information distributing apparatus 300 receives the media ID transmitted by the information recording apparatus 200. It generates the encryption information Key1, such as a disk key, corresponding to the received media ID, and the encryption information Key2, such as a title key. On the basis of the generated encryption information Key 1 and Key2, the information distributing apparatus 300 performs an encryption process, such as encryption, on the contents. Then, it distributes the contents on which the encryption process is performed, i.e. the encrypted contents, to the information recording apparatus 200. Incidentally, the encrypted contents are distributed via the external network 400, so that encryption corresponding to eavesdropping and falsification or the like, such as a SSL (Secure Socket Layer), may be performed, aside from the encryption in the encryption process.

The external network 400 connects the information recording apparatus 200 and the information distributing apparatus 300 so as to exchange the information, through a not-illustrated line connecting apparatus provided for the both apparatuses (e.g. a hub apparatus, a digital service unit (DSU), or a router with firewall application for preventing invasion mounted thereon).

(Distribution Process on Information Recording Medium, Information Recording Apparatus, and Information Distributing Apparatus)

Next, with reference to the above-mentioned FIG. 4 in addition to FIG. 5, an explanation will be given for a distribution process of the distribution system, provided with: the information recording apparatus for performing the recording operation on the information recording medium of the present invention; and the information distributing apparatus for performing the distribution operation. FIG. 5 is a flowchart showing the distribution process on the information recording medium, the information recording apparatus, and the information distributing apparatus of the present invention. Incidentally, the step numbers in FIG. 5 correspond to those in FIG. 4.

(Operation on Information Recording Apparatus)

Firstly, in FIG. 5, if the optical disc 100 is inserted, a seek operation is performed by an optical pickup 202 under the control of a CPU (Central Processing Unit) 250 of the information recording apparatus described later (step S101).

Then, under the control of the CPU 250, it is judged whether or not the optical disc 100 is an optical disc for content distribution (step S102). Here, if the optical disc 100 is the optical disc for content distribution (the step S102: Yes), various control information and various management information necessary for the recording operation onto the optical disc 100 are obtained (step S103). More specifically, an OPC process is performed, to thereby determine an optimum recording power and determine a recording strategy pattern. At the same time, the flag information indicating whether or not there is the read-only area ROM, and the start and end addresses indicating the start and end positions of the read-only area ROM are obtained.

Then, it is judged whether or not the contents are already recorded on the optical disc 100 (step S104). Here, if the contents are not recorded yet on the optical disc 100 (the step S104: No), the media ID peculiar to the optical disc 100 is obtained from the NBCA (Narrow Burst Cutting Area) on the optical disc 100 under the control of the CPU 250 (step S105).

Then, under the control of the CPU 250, the obtained media ID is encrypted on the basis of the SSL or the like, and transmitted to the information distributing apparatus 300, such as a server on the network, for example (step S106).

On the other hand, as a result of the judgment in the step S102, if it is judged that the optical disc 100 is not the optical disc for content distribution (the step S102: No), and as a result of the judgment in the step S104, if it is judged that the contents are already recorded on the optical disc 100 (the step S104: Yes), the optical disc 100 is ejected from the information recording apparatus 200.

(Operation on Information Distributing Apparatus)

On the information distributing apparatus 300, firstly the media ID encrypted by the SSL or the like is received (step S201).

Then, on the information distributing apparatus 300, the received media ID encrypted by the SSL or the like is decoded (step S202).

Then, on the information distributing apparatus 300, the encryption information Key 1, such as a disk key, corresponding to the decoded media ID, and the encryption information Key 2, such as a title key, are generated (step S203).

Then, on the information distributing apparatus 300, contents and a file system distributed by using the generated encryption information Key 1 and Key2 are encrypted in the predetermined encryption system (step S204).

Then, on the information distributing apparatus 300, the encrypted contents and file system, encrypted on the basis of the encryption system by using the generated encryption information Key 1 and Key2, are further encrypted by the SSL or the like, and distributed to the information recording apparatus 200 (step S205). More specifically, the attribute of the encrypted contents and file system encrypted by the SSL or the like, i.e. CCI (Copy Control Information), is set to the attribute of Never Copy so as not to be reproduced, in the middle of the distribution.

(Operation on Information Recording Apparatus—Continued—)

Again, on the information recording apparatus 200, the encrypted contents and file system, encrypted by the SSL or the like and distributed by the information distributing apparatus, are received (step S107).

Then, on the information recording apparatus 200, the received encrypted contents and file system are decoded by the SSL or the like (step S108).

Then, on the information recording apparatus 200, the encrypted contents and file system encrypted by using the encryption information Key 1 and Key2, are not decoded and recorded onto the optical disc 100 as they are (step S109). More specifically, the recording of the encrypted contents and file system encrypted on the basis of the predetermined encryption system, is started from the address of the last recording area of the lead-in area 101 which is not prerecorded, and it is ended at the address of the recording area of the data area 102 which is pre-recorded. If the recording of the encrypted contents and file system is not performed up to the address of the recording area of the data area 102 which is prerecorded, buffer data may be recorded up to this address. Incidentally, if the main story video images of DVD video contents, which are planning to be distributed, have a small data amount and if the data amount of the buffer data to be recorded can be reduced more when the common DVD video contents, such as opening video information peculiar to each film company, are recorded, all the DVD video contents may be distributed including the opening video information and the main story video images.

As described above, the distribution system in the embodiment transmits and receives the media ID, instead of the encryption information Key 1 and Key2, in exchanging the information through the external network 400 between the information recording apparatus 200 and the information distributing apparatus 300. Therefore, it is possible to highly maintain the confidentiality of the encryption information Key1 prerecorded in the encryption information recording area; namely, it is possible to set a secure condition. Thus, it is hardly possible or not possible at all to prepare or manufacture the record-type information recording medium on which the encryption information Key1 is illegally copied.

(Information Recording/Reproducing Apparatus)

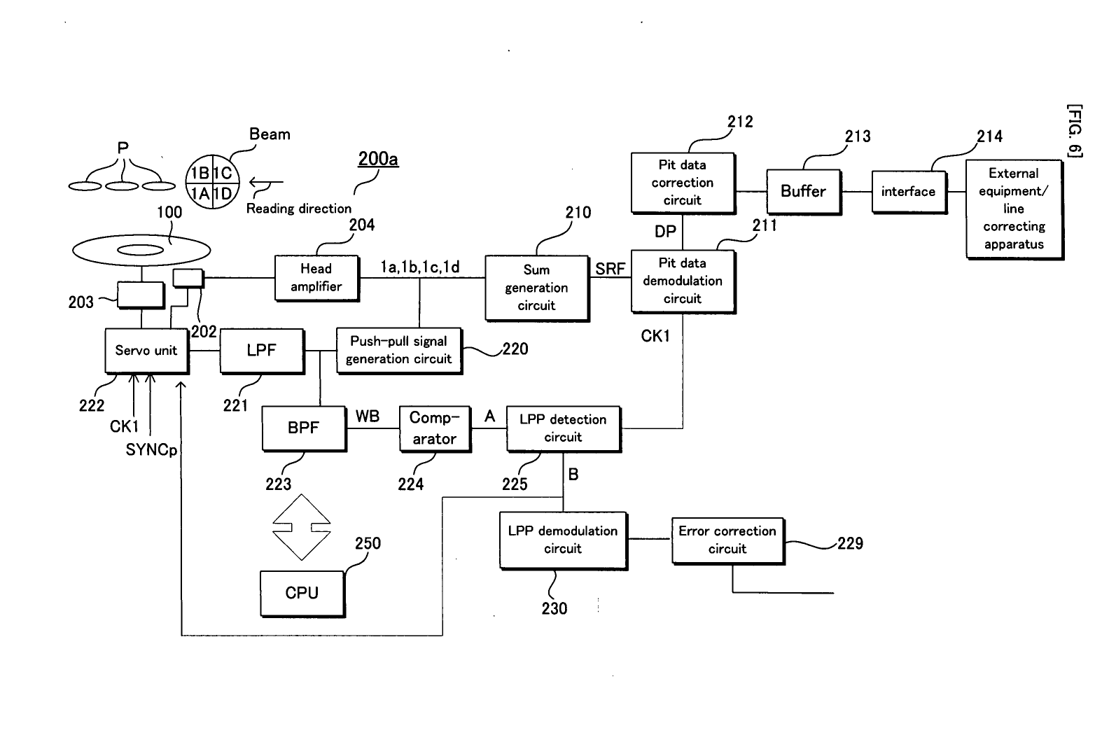

Next, with reference to FIG. 6, an explanation will be given for an information recording/reproducing apparatus for recording and reproducing the information on the information recording medium of the present invention. This information recording/reproducing apparatus 200a includes the information recording apparatus 200. FIG. 6 is a block diagram showing the entire structure of the information recording/reproducing apparatus for recording and reproducing the information on the information recording medium of the present invention. On the optical disc 100, pit data DP synchronized with a first clock signal CK1 is recorded in accordance with the length of a record mark. The record mark in this example is a pit, and the track is constructed from a pit row. The track has a meandering shape in accordance with a wobble signal WB. The wobble signal WB is synchronized with the first clock signal CK1.

The information recording/reproducing apparatus 200a is provided with: an optical pickup 202 for irradiating a reproduction beam onto the optical disc 100 and outputting a signal responding to reflected light; a spindle motor 203 for controlling the rotation of the optical disc 100; and a servo unit 222. The first clock signal CK1 and a pit synchronization signal SYNCp are supplied to the servo unit 222. The servo unit 222 is synchronized with these signals, and performs spindle servo for controlling the rotation of the spindle motor 203, and focus servo and tracking servo for performing relative position control of the optical pickup 202 to the optical disc 100.

The optical pickup 202 is provided with a laser diode for irradiating the reproduction beam; and a four-division detection circuit (not-illustrated). The four-division detection circuit divides the reflected light of the reproduction beam into four areas 1A, 1B, 1C, and 1D shown in FIG. 8, and outputs each signal corresponding to the quantity of light in respective one of the areas. A head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D. Incidentally, the optical pickup 202 and the head amplifier 204 correspond to the optical pickup device of the present invention.

A sum generation circuit 210 is provided with an adder circuit for adding the divisional read signals 1a, 1b, 1c, and 1d and for outputting a sum read signal SRF. Incidentally, the sum read signal SRF is a signal which represents the length of the record mark.

A pit data demodulation circuit 211 reproduces the pit data DP on the basis of the sum read signal SRF, and generates the first clock signal CK1. More specifically, the reproduced pit data DP is demodulated by using a predetermined table, to thereby generate reproduction data. For example, if EFM modulation is adopted as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to a pit data correction circuit 212 shown in FIG. 6, on which an error correction process and an interpolation process are performed, and then, it is stored into a buffer 213. An interface 214 sequentially reads the data stored in the buffer 213, converts it in a predetermined output format, and outputs it to external equipment. Moreover, through this interface 214, the various data is inputted and outputted to the above-mentioned line connecting apparatus connected to an external network 400, for example.

A push-pull signal generation circuit 220 calculates (1a+1d)−(1b+1c) and generates a push-pull signal. The component (1a+1d) corresponds to the areas 1A and 1D which are on the left side with respect to the reading direction, while the component (1b+1c) corresponds to the areas 1B and 1C which are on the right side with respect to the reading direction. Namely, if the reproduction beam is disproportionately on the left with respect to the pit, the push-pull signal is positive on the basis of the center of amplitude. If the reproduction beam is located in the center of the pit, the value of the push-pull signal is in the center of amplitude. If the reproduction beam is disproportionately on the right with respect to the pit, the push-pull signal is negative on the basis of the center of amplitude. The relative position of the reproduction beam and the pit varies depending on the meandering of the track, and the value of the push-pull signal indicates a relative position relationship between the reproduction beam and the pit. Namely, the push-pull signal is a signal corresponding to the meandering of the track.

The push-pull signal is outputted to the servo unit 222 through a low pass filter 221. The servo unit 222 performs the tracking control on the basis of the push-pull signal. Moreover, the push-pull signal is supplied to a band pass filter 223. The passband of the band pass filter 223 is set to extract the wobble signal WB obtained by the spread spectrum modulation of the wobble data DW from the push-pull signal at the time of recording. Therefore, the band pass filter 223 constitutes the above-mentioned detecting device, together with the push-pull signal generation circuit 220, and its output signal is obtained by reproducing the wobble signal WB from the optical disc 100. In particular, on a comparator 224, if it is tried to perform the illegal writing into the encryption information recording area (e.g., the control data zone), the recording clock and the recording address cannot be detected in the special area of the present invention, so that errors occur in the recording operation, and the recording operation is stopped. Thus, it is possible to prevent the illegal writing into the encryption information recording area, regardless of the specification of the information recording apparatus and its recording control procedure. Namely, it is possible to make PLL (Phase Lock Loop) out of control.

A LPP detection circuit 225 is constructed to detect a LPP signal on the basis of an output signal A from the comparator 224 and the first clock signal CK1 generated on the pit data demodulation circuit 211. Then, it is constructed to output the LPP signal B to a LPP demodulation circuit 230 and the servo unit 222.

The LPP demodulation circuit 230 is constructed to demodulate the LPP signal B to the pre-format address information. Then, it is constructed to output the pre-format address information to an error correction circuit 229.

The error correction circuit 229 performs error correction on the pre-format address information, which is demodulated by the LPP demodulation circuit 230.

A CPU 250 controls each of the constitutional elements of the information recording/reproducing apparatus 200a.

(Flow of Reproduction Operation by Embodiment of Information Recording/Reproducing Apparatus)

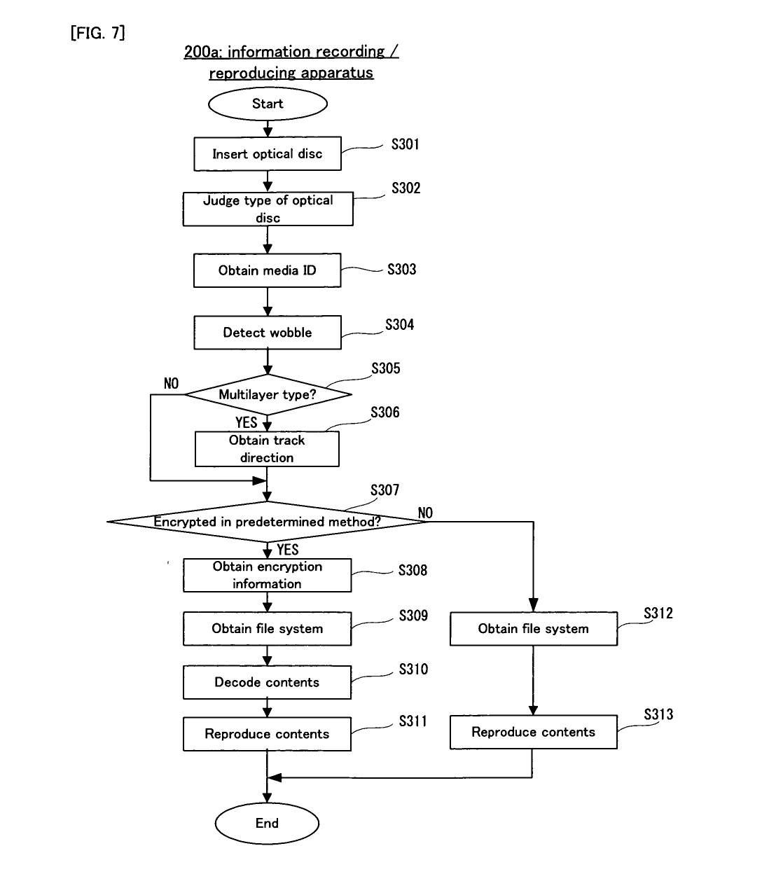

Next, with reference to FIG. 7, an explanation will be given for a reproduction operation in an embodiment of the information recording/reproducing apparatus for reproducing information on the information recording medium of the present invention. FIG. 7 is a flowchart showing a flow of the reproduction operation in one specific example of the embodiment of the information recording/reproducing apparatus of the present invention.

Firstly, in FIG. 7, if the optical disc 100 is inserted, the seek operation is performed by the optical pickup 202 under the control of the CPU 250 (step S301).

Then, under the control of the CPU 250, the type of the optical disc 100 is judged (step S302).

Then, under the control of the CPU 250, the media ID is obtained (step S303).

Then, under the control of the CPU 250, information about whether or not the optical disc 100 is the record-type information recording medium is obtained (step S304). More specifically, by judging whether or not the wobble or the like can be detected, it is possible to judge whether or not the optical disc 100 is the record-type information recording medium.

Then, under the control of the CPU 250, information about the number of recording layers of the optical disc 100 is obtained, and it is judged whether or not the optical disc 100 is a multilayer type information recording medium (step S305). Namely, under the control of the CPU 250, it is possible to judge whether or not the optical disc 100 is a single layer type or a multilayer type information recording medium, such as a dual-layer type. Here, if it is judged that the optical disc 100 is the multilayer type information recording medium, such as the dual-layer type (the step S305: Yes), information about the direction of the recording track of the optical disc 100 is obtained under the control of the CPU 250 (step S306). More specifically, it is possible to judge whether the optical disc 100 adopts a parallel method or an opposite method.

On the other hand, if it is judged that the optical disc 100 is not the multilayer type information recording medium, such as the dual-layer type (the step S305: No), the optical disc 100 is the single layer type information recording medium. Thus, the step S306 of obtaining the information about the direction of the recording track of the optical disc 100 is omitted.

Then, under the control of the CPU 250, it is judged whether or not the contents and the file system recorded in a user data area, for example, of the optical disc 100 are encrypted on the basis of the predetermine encryption system (step S307). Here, for example, if the contents recorded in the data area 102 of the optical disc 100 are encrypted on the basis of the encryption system (the step S307: Yes), the encryption information Key2, such as a title key, is obtained (step S308).

Then, under the control of the CPU 250, information about the file system of the optical disc 100 is obtained (step S309).

Then, under the control of the CPU 250, the contents encrypted and recorded on the optical disc 100 are decoded by using the obtained encryption information Key2, such as a title key, for example (step S310).

As descried above, under the control of the CPU 250, the reproduction is performed for each decoded content, by using the encryption information Key2, such as a title key, for example (step S311).

On the other hand, if the contents recorded in the user data area, for example, of the optical disc 100 are not encrypted on the basis of the encryption system (the step S307: No), the information about the file system is obtained under the control of the CPU 250 (step S312).

As described above, the contents are reproduced under the control of the CPU 250 (step S313).

In the embodiment, as one specific example of the information recording medium, the hybrid type optical disc is explained. The present invention, however, can be also applied to all types of optical information recording media, such as CDs and DVDs, and a large-volume recording medium like a Blu-ray disc, for example.

The present invention is not limited to the above-described embodiment, and various changes may be made, if desired, without departing from the essence or spirit of the invention which can be read from the claims and the entire specification. An information recording medium which involves such changes, is also intended to be within the technical scope of the present invention.

### INDUSTRIAL APPLICABILITY

The information recording medium of the present invention can be applied to an information recording medium, such as a DVD.

1. An information recording medium, comprising:
a record information recording area in which (i) reproduction control information and (ii) first record information reproduced in accordance with the reproduction control information can be recorded;
an encryption information recording area in which encryption information for encrypting at least one of the reproduction control information and the first record information is recorded in advance; and
a read-only area in which second record information reproduced in accordance with the reproduction control information is, prerecorded in advance.

2. The information recording medium according to claim 1, wherein the second record information is encrypted and prerecorded on the basis of the encryption information.

3. The information recording medium according to claim 1, wherein
a plurality of second record information is prerecorded in said read-only area, correspondingly to a plurality of type of contents, and
the reproduction control information specifies at least one of the plurality of second record information and allows the reproduction thereof.

4. The information recording medium according to claim 3, wherein
the plurality of second record information (i) is respectively encrypted by a mutually different plurality of encryption information and (ii) is respectively prerecorded in advance in said read-only area, and
one of the plurality of encryption information is prerecorded in advance in said encryption information recording area.

5. The information recording medium according to claim 3, wherein
all the plurality of second record information is encrypted by one kind of encryption information and prerecorded in advance in said read-only area, and
the one kind of encryption information is prerecorded in advance in said encryption information recording area.

6. The information recording medium according to claim 1, wherein the second record information is prerecorded without being encrypted by the encryption information.

7. The information recording medium according to claim 1, wherein
the encryption information is information for further encrypting another encryption information for encrypting the first record information, and
the another encryption information is recorded into said record information recording area with the first record information.

8. The information recording medium according to claim 1, further comprising a control information recording area in which control information about reproduction control and recording control, can be recorded,
flag information being recorded in the control information recording area, the flag information indicating whether or not there is said read-only area.

9. The information recording medium according to claim 8, wherein at least one of (i) attribute information about attribute and the number of the second record information prerecorded in said read-only area, (ii) start address information, and (iii) end address information is recorded in the control information recording area, (ii-a) the start address information indicating a start position of said read-only area, (iii-a) the end address information indicating an end position of said read-only area.

10. The information recording medium according to claim 1, wherein
pre-format address information is recorded in at least one of said record information recording area and said encryption information recording area, and
flag information indicating whether or not there is said read-only area is appended to the pre-format address information.

11. The information recording medium according to claim 10, wherein at least one of (i) attribute information about attribute and the number of the second record information prerecorded in said read-only area, (ii) start address information, and (iii) end address information is appended to the pre-format address information, (ii-a) the start address information indicating a start position of said read-only area, (iii-a) the end address information indicating an end position of said read-only area.
